(19) United States
(12) Patent Application Publication
(10) Pub. No.: US 2007/0277788 A1
(43) Pub. Date: Dec. 6, 2007

(54) Transpiration Fuel Gas Adsorbent and Process for Producing the Same

(75) Inventors: Yoshifumi Egawa, Okayama-ken (JP); Takanori Kitamurai, Okayama-ken (JP); Susumu Abe, Okayama-ken (JP); Shizuo Ishimura, Okayama-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kuraray Chemical Co., Ltd., Bizen-shi (JP)

(21) Appl. No.: 11/572,195

(22) PCT Filed: Aug. 9, 2005
(86) PCT No.: PCT/JP05/14582

§ 371 Date: Jan. 16, 2007

(30) Foreign Application Priority Data
Aug. 18, 2004 (JP) 2004-238024

(51) Int. Cl. F02M 33/02

(52) U.S. Cl. 123/519; 502/430

(57) ABSTRACT

A high-density evaporated fuel gas adsorbent and process for forming such capable of preventing temperature rise and temperature fall caused with adsorption and desorption of an evaporated fuel gas, capable of stably maintaining adsorbing and desorbing properties of the adsorbent, and capable of preventing a heat storage component from leaking out therefrom. The adsorbent is formed by mixing together microcapsules in each of which a substance that absorbs or releases heat in response to phase change is encased and activated carbon in which pore volume in an average pore diameter of 50 nm to 1000 nm is 0.3 mL/g or more and in which half-value width of a D-band peak in the vicinity of 1360 cm⁻¹ and half-value width of a G-band peak in the vicinity of 1580 cm⁻¹ are both equal to 100 cm⁻¹ or more in a Raman spectroscopic analysis, and by molding these integrally.

### BACKGROUND OF THE INVENTION

1. Field of the Invention

The present invention relates to an evaporated fuel gas adsorbent and a process for producing the adsorbent. More particularly, the present invention relates to an evaporated fuel gas adsorbent in which microcapsules each of which is filled with a substance that absorbs or releases heat in response to phase change and activated carbon are mixed together and are molded integrally in which the pore volume in the average pore diameter of not less than 50 nm and not more than 100 nm of the activated carbon is 0.3 mL/g or more, and in which both the half-value width of a D-band peak in the vicinity of 1360 cm⁻¹ and the half-value width of a D-band peak in the vicinity of 1580 cm⁻¹ are 100 cm⁻¹ or more according to a Raman spectroscopic analysis and relates to a process for producing the evaporated fuel gas adsorbent

2. Description of the Prior Art

Conventionally, it is known that a porous adsorptive material such as activated carbon, is used to adsorb evaporated fuel gas i.e., gas resulting from the evaporation of fuel). This porous adsorptive material is used as a canister mounted on a vehicle. However if the porous adsorptive material, such as activated carbon, is used as an adsorbent serving to adsorb evaporated fuel gas, the following essential problems will occur In detail, the adsorptivity of an adsorbent that adsorbs evaporated fuel gas is enhanced in proportion to a fall in temperature of the adsorbent, whereas the desorptivity thereof is enhanced in proportion to a rise in temperature of the adsorbent.

However, when evaporated fuel gas generated in, for example, a vehicle is adsorbed by a porous adsorptive material, such as activated carbon, heat generation due to heat of adsorption causes the adsorptivity to exhibit a falling tendency. On the other hand, when desorbed, absorption of heat causes the desorptivity to exhibit a falling tendency. Therefore, if the porous adsorptive material, such as activated carbon, is used as an adsorbent, which adsorbs evaporated fuel gas, in the unchanged form, the adsorptivity and desorptivity of the activated carbon cannot be sufficiently displayed. This is inefficient. To solve this problem, there is a method of flowing a medium, such as water, so as to control temperature.

However, according to this method, although temperature control can be easily performed in the vicinity of the medium, the adsorbent is low in thermal conductivity. Therefore, much time is consumed to control the temperature inside the adsorbent. Additionally, equipment used to flow the medium and utilities for driving are required.

An evaporated fuel collecting apparatus is also known. In this apparatus, a solid heat storage material having greater specific heat than activated carbon is mixed in the activated carbon while being dispersed, and metallic materials, various ceramics, glass, or inorganic materials are used as the solid heat storage material (see Patent Document 1: Japanese Published Unexamined Patent Application No. S64-36962). However, the evaporated fuel collecting apparatus disclosed by this document uses sensible heat. Therefore, since a thermal disadvantage occurs in comparison with calories required to improve the adsorption and desorption, there is a need to mix a large amount of solid heat storage materials therein in order to enhance the effect. As a result, disadvantageously, the ratio of the activated carbon decreases relatively, and the total amount of adsorption cannot be improved even if the problem of temperature arising when adsorbed or desorbed is solved

Another evaporated fuel collecting apparatus is known (see Patent Document 2: Japanese Published Unexamined Utility Model Application No. S63-057351). In this apparatus, an adsorbent in which a porous body containing a latent-heat storage material that works at a temperature of preferably 50° C. to 70° C. and activated carbon are combined together is used. It is also known that a latent-heat storage type adsorbent composed of a heat storage material containing a microencapsulated material capable of absorbing or releasing latent heat in response to temperature change and an adsorbent is used for canisters (see Patent Document 3: International Publication WO03/106833 A1). According to the adsorbents disclosed in Patent Documents 2 and 3, a decrease in performance resulting from the incoming and outgoing flow of heat in accordance with adsorption and desorption can be prevented, i.e., a rise in temperature resulting from heat generation caused when adsorbed and a drop in temperature resulting from heat absorption caused when desorbed can be prevented. Therefore, presumably, the adsorbents mentioned in Patent Documents 2 and 3 are useful in improving the performance of a canister that generates a thermal incoming and outgoing flow in accordance with adsorption and desorption.

The adsorbent including the microcapsules mentioned in Patent Documents 2 and 3 uses the phase-changing material that absorbs or releases latent heat in response to temperature change as a heat storage material, and hence it is expected that an effect will be brought about by mixing a small amount of heat storage material. However, there is a practical problem. For example even if the step of uniformly mixing and drying a liquid in which microcapsules are dispersed and an adsorbent together is merely performed, pores of the adsorbent are closed when used, and, as a result, the adsorptivity will be lowered, or the microcapsule filled with the heat storage material and the adsorbent will be separated from each other owing to, for example, vibrations, and hence the intrinsic heat absorbing and generating properties thereof cannot be shown.

Patent Document 3 additionally proposes a method of mixing microcapsules in each of which a powdery heat storage material is encapsulated and an adsorbent together and molding these under compression. According to this method, it seems that close contact between the heat storage material and the adsorbent is effective from the viewpoint of heat transfer efficiency. However, there is a fear that the microcapsules will be broken so that heat storage components leak out when molded under compression. Therefore, to mold these so as not to break the microcapsules, there is a need to lower the molding pressure. As a result, the amount of activated carbon for each unit volume decreases although the problem of temperature caused when adsorbed and desorbed is solved. Therefore, the total amount of adsorption does not increase as before.

It is therefore an object of the present invention to provide a high-density evaporated-fuel gas adsorbent capable of preventing a temperature rise and a temperature drop caused by the adsorption and desorption of evaporated fuel gas capable of stably maintaining the adsorptivity and desorptivity of the adsorbent, and capable of removing the possibility that heat storage components will leak out, and provide a process for producing the adsorbent.

### SUMMARY OF THE INVENTION

To achieve the object, the present inventors have paid attention to the pore volume in a specific pore diameter of activated carbon and to a half-value width of a D-band peak and a half-value width of a G-band peak of a specific wavelength in a Raman spectroscopic analysis, and, as a result of diligent and repeated research, have reached the present invention. In more detail, the present invention is an evaporated fuel gas adsorbent in which microcapsules each of which is filled with a substance that absorbs or releases heat in response to phase change (hereinafter, this substance is abbreviated as “latent-heat storage material”) and activated carbon are mixed together and are molded integrally, and is characterized in that the pore volume in the average pore diameter of not less than 50 nm and not more than 100 nm of the activated carbon is 0.3 mL/g or more, and in that both the half-value width of a D-band peak in the vicinity of 1360 cm⁻¹ and the half-value width of a G-band peak in the vicinity of 1580 cm⁻¹ are 100 cm⁻¹ or more according to a Raman spectroscopic analysis.

Additionally, the present invention is a process for producing an evaporated fuel gas adsorbent in such a way that powdery activated carbon and granular or powdery microcapsules each of which is filled with a latent-heat storage material are mixed together in a solution chiefly composed of latex, carboxymethyl cellulose, and water, are then subjected to wet molding, and are dried.

According to the present invention, it is possible to provide an evaporated fuel gas adsorbent, in which microcapsules each of which is filled with a latent-heat storage material, and activated carbon, in which the pore volume in an average pore diameter of not less than 50 nm and not more than 100 nm is 0.3 mL/g or more and in which both the half-value width of a D-band peak in the vicinity of 1360 cm⁻¹ and the half-value width of a G-band peak in the vicinity of 1580 cm⁻¹ are 100 cm⁻¹ or more according to a Raman spectroscopic analysis, are mixed together and are molded integrally, and provide a process for producing the adsorbent. According to the evaporated fuel gas adsorbent of the present invention, heat generated in accordance with the adsorption and desorption of evaporated fuel gas can be efficiently managed, and hence the evaporated fuel gas adsorbent can maintain its high performance, and can be suitably used in, for example, canisters.

### DESCRIPTION OF THE PREFERRED EMBODIMENTS

It is preferable from the viewpoint of energy efficiency to use an organic compound that undergoes phase changes at −10° C. to 100° C., more preferably at 20° C. to 70° C., as the latent-heat storage material used in the present invention. A hydrocarbon compound such as decane, dodecane, tetradecane, pentadecane, hexadecane octadecane, eicosane, or paraffin, higher alcohol, such as lauryl alcohol, myristyl alcohol, cetyl alcohol, stearyl alcohol, eicosanol, or ceryl alcohol, higher fatty acid, such as lauric acid, myristic acid, stearic acid, oleic acid, or behenic acid, glyceride of this higher fatty acid thereof, amides, such as propion amide, polyethylene glycols, such as PEG400, PEG600, PEG1000, PEG2000, PEG4000, or PEG6000, phenols, such as phenol, or a mixture of these compounds can be mentioned as the organic compound.

To prevent the supercooling of the latent-heat storage material, the latent-heat storage material may contain a compound having a higher melting point than that of the latent-heat storage material. Preferably, the content ratio of the compound having such a high melting point to the latent-heat storage material is 0.5 to 30% by weight, and more preferably, 1 to 15% by weight For example, an aliphatic hydrocarbon compound, an aromatic compound, esters, carboxylic acids, alcohols, or amides can be mentioned as the compound having such a high melting point.

Additionally, concrete examples of a combination of the latent-heat storage material and the high-melting compound are as follows. For example, when octadecane is used as the latent-heat storage material, it is recommended to use cetyl alcohol, stearyl alcohol, eicosanol, myristic acid, behenic acid, or stearic acid amide as the high-melting compound to be contained in the latent-heat storage material. It is permissible to mix two or more kinds of high-melting compounds, such as those mentioned above, together.

Fine particles of an inorganic compound, such as talc, silica, titanium dioxide, silicate calcium, or antimony trioxide, or fine particles of an organic acid salt, such as magnesium stearate or sodium benzoate, can be mentioned as substances that are not listed above and that are allowed to be contained in the latent-heat storage material to prevent the supercooling thereof. When polyethylene glycols are used as the latent-heat storage material, especially a drop in a crystallization temperature in a temperature decrease is sharp. Therefore, to advance the crystallization, it is preferable to add these substances by which the supercooling is prevented.

A known microcapsule can be used as the one in which a latent-heat storage material is encased and should, of course, be used as the one from which the latent-heat storage material does not easily leak out when the latent-heat storage material reaches a melt temperature. For example, a microcapsule manufactured by Mitsubishi Paper Mills Limited or Osaka Gas Co., Ltd., can be used as the microcapsule in which a latent-heat storage material is encased. Without being limited to this, it is also possible to use a polymer-microencapsulated latent-heat storage material or an encapsulated latent-heat storage material formed by allowing polyolefin or the like to absorb an organic latent-heat storage material and allowing its surface to be coated with resin.

From the necessity of absorbing and releasing an adequate amount of calories in a practical manner, the latent heat of a microcapsule in which a latent-heat storage material is encased is preferably 80 mJ/mg or more, and more preferably 100 mJ/mg or more. The term “latent heat” mentioned here denotes apparent latent heat of the whole of a microcapsule in which a latent-heat storage material is encased, which can be easily measured with a differential scanning calorimeter.

In the present invention, a microcapsule in which a latent-heat storage material is encased is mixed with activated carbon, and is molded integrally therewith. No specific limitations are imposed on a carbonaceous material that is the raw material of activated carbon if it forms activated carbon by activation. The carbonaceous material can be selected from various categories, i.e., from a plant-based material, a mineral-based material, a natural material, and a synthetic material. In more detail, wood, charcoal, or coconuts shells, such as fruit shells, can be mentioned as a plant-based carbonaceous material. Petroleum and/or coal-tar pitch or coke can be mentioned as a mineral-based carbonaceous material. Natural fiber, such as cotton or flax, regenerated fiber, such as rayon or viscose rayon, or semisynthetic fiber, such as acetate or triacetate, can be mentioned as a natural material. Polyamide resin, such as nylon, polyvinyl alcohol resin, such as vinylon, polyacrylonitrile resin, such as acrylic, polyolefin resin, such as polyethylene or polypropylene, polyurethane resin, phenol resin, or polyvinyl chloride resin can be mentioned as a synthetic material. Especially, the plant-based carbonaceous material is desirable, because this has many macropores at the stage of the raw material.

No specific limitations are imposed on the carbonaceous material and the shape of activated carbon obtained by activating this carbonaceous material. It is possible to use a carbonaceous material having various shapes such as a granular, powdery, fibrous, or sheet-like shape. Woven or unwoven cloth, film, felt, or sheet-shaped material including natural cellulose fiber, such as cotton, regenerated cellulose fiber, such as viscose rayon or polynosic rayon, pulp fiber, and synthetic fiber, such as polyvinyl alcohol fiber, ethylene vinyl alcohol fiber, or phenol fiber, can be mentioned as a fibrous or sheet-shaped carbonaceous material.

The carbonaceous material is turned into activated carbon by being carbonized and activated. For example, the condition that the carbonaceous material is processed at 300° C. or more while passing a small amount of inert gas through a batch-wise rotary kiln can be employed as the carbonizing condition. It is permissible to use various methods, such as gas activation or agent activation, as the activating method. Steam, carbon dioxide, oxygen, LPG exhaust combustion gas, or a mixture of these gases can be mentioned as gas used in the gas activation method. Normally, the activation temperature thereof is raised up to 300° C. to 1200° C. preferably up to 900° C.

Acid, such as sulfuric acid, phosphoric acid, or nitric acid, metal hydroxide, such as sodium hydroxide, potassium hydroxide, cesium hydroxide, calcium hydroxide, or magnesium hydroxide, or metal chloride, such as calcium chloride or zinc chloride, can be mentioned as an agent used in the agent activation method. Normally, the activation temperature thereof falls within the range of 300° C. to 800° C., though it depends on the agent to be used herein.

Activated carbon obtained from a variety of carbonaceous materials is mixed with a microencapsulated latent-heat storage material, and is molded integrally therewith. Preferably, to obtain a uniform mixture, the center particle diameter of the activated carbon is 1 to 100 μm. No specific limitation is imposed on a method for pulverizing the activated carbon. It is recommended to use a known pulverizing means. What is required of the activated carbon is to satisfy the pore volume and the Raman spectroscopic analysis value mentioned above. Therefore, the same kind of activated carbon may be used solely, or different kinds of activated carbon may be mixed together. It is permissible to mix together a plurality of activated carbon obtained according to different activating methods and use the resulting mixture. When different kinds of activated carbon are mixed together and are used, it is recommended to use activated carbon at least 50% or more of which is a plant-based carbonaceous material.

A dominant feature of the present invention resides in the fact that the pore volume in an average pore diameter of 50 nm to 1000 nm of activated carbon measured according to a mercury injection method is 0.3 mL/g or more, and in the fact that, in the activated carbon to be used here, the half-value width of a D-band peak in the vicinity of 1360 cm⁻¹ and the half-value width of a G-band peak in the vicinity of 1580 cm⁻¹ in a Raman spectroscopic analysis are both equal to 100 cm⁻¹ or more. The use of this activated carbon makes it possible to produce an evaporated fuel gas adsorbent that is in close contact with a latent-heat storage material, and makes it possible to perform compression molding without allowing the latent-heat storage material to leak out from a microcapsule in which the latent-heat storage material is encased. Therefore, it becomes possible to produce an evaporated fuel gas adsorbent superior in heat transfer efficiency.

A clear description cannot necessarily be given of a reason why an evaporated fuel gas adsorbent superior in heat transfer efficiency can be obtained by using activated carbon that satisfies a specific pore volume and a specific Raman spectroscopic analysis value. Presumably, the reason is that the density is increased by smashing the macropores during compression molding because the carbonaceous material itself is soft, and that compression molding can be performed without allowing the latent-heat storage material to leak out from the microcapsule because an excessive force is not exerted onto the microencapsulated latent-heat storage material.

Preferably, activated carbon used in the present invention is high in butane working capacity (BWC). If the BWC is too low, the amount of heat generated when an evaporated fuel gas is adsorbed will be small, or the amount of heat absorbed when the evaporated fuel gas is desorbed will be small. This often causes a phenomenon in which the effect of the latent-heat storage material is not easily displayed. Therefore, preferably, the value measured in accordance with ASTM-D5228 is 9 or more. The BWC measured in accordance with ASTM-D5228 is hereinafter referred to as BWC/ASTM, in distinction from BWC described later.

Next, a method for producing the evaporated fuel gas adsorbent will be described. No specific limitation is imposed on a process for mixing together a microencapsulated latent-heat storage material and activated carbon and then molding these. Therefore it is recommended to mold these with an ordinary briquette machine or an extrusion molding machine. Since the microcapsule is often broken when a share is unnecessarily applied, it is recommended to mold these with a tablet compression machine, a ring die pelleter or a plunger type extruding machine.

Preferably, a binder used during molding has high adhesive properties, and has the property of not hindering the adsorptivity of activated carbon. Preferably, the usage of the binder is as small as possible. In more detail, activated carbon whose center particle diameter is 1 to 100 μm and granular or powdery microcapsules in each of which a latent-heat storage material is encased are mixed together in an emulsion solution serving as a binder, are then subjected to wet molding, and are dried, thus producing an evaporated fuel gas adsorbent of the present invention.

For example, vinyl acetate emulsion, vinyl acetate and ethylene copolymer emulsion, polybutadiene emulsion, polyvinyl chloride emulsion, NBR-latex-based or copolymer-nylon-based or copolymer-polyester-based emulsion can be mentioned as the emulsion. Preferably, the emulsion has resistance against fuel. These emulsions can be used solely, or can be used in the form of a combination made by two or more kinds of emulsions. Especially. NBR latex is desirable. To improve the lubricity needed when molded, it is preferable to use together carboxymethyl cellulose (CMC) or the like.

Concerning the emulsion mixture ratio, it is preferable to use as small amounts of emulsion as possible if sufficient strength can be secured. Preferably, the components are mixed together in the following ratio, i.e., 65 parts by weight to 85 parts by weight of activated carbon: 80 parts by weight to 150 parts by weight of water: 5 parts by weight to 30 parts by weight of latex: 0.5 parts by weight to 5 parts by weight of CMC, and are dried at 80 to 120° C., thus producing an evaporated fuel gas adsorbent of the present invention.

In the evaporated fuel gas adsorbent of the present invention, if a too small content of latent-heat storage material is provided, sufficient heat storage ability cannot be shown. On the other hand, if a too large content of latent-heat storage material is provided the amount of activated carbon becomes insufficient. As a result, the total amount of adsorption does not increase although the problem of temperature occurring when adsorbed and desorbed is solved. Therefore, it is recommended to set the content percentage of the latent-heat storage material at 5% by weight to 40% by weight, preferably 10% by weight to 30% by weight. To improve the adsorptivity and desorptivity while restraining the heat generation occurring when an evaporated fuel gas is adsorbed or the heat absorption occurring when the evaporated fuel gas is desorbed the apparent latent heat of a molded evaporated fuel gas adsorbent is preferably 20 mJ/mg or more, and more preferably 30 mJ/mg or more.

The term “latent heat” mentioned here denotes the apparent latent heat of the whole of an evaporated fuel gas adsorbent in which microcapsules in each of which a latent-heat storage material is encased and activated carbon are molded integrally. The apparent latent heat can be easily measured with a differential scanning calorimeter. If the average particle diameter of the evaporated fuel gas adsorbent is set at 0.5 to 5 mm, sufficient practicality and usability will be obtained, and hence it is preferable to set the average particle diameter thereat. The present invention will be described in more detail with reference to the following examples. However, the present invention is not limited to these, of course.

The melting point, the melting heat, the crystallization temperature in a temperature decrease and the crystallization heat of the latent-heat storage material were measured with a differential scanning calorimeter (EXSTAR6000 RDC220U) of Seiko Instruments Inc. at the temperature rise speed and the temperature fall speed of 5° C./minute. The latent heat was shown by an average value of the melting heat and the crystallization heat.

The pore volume in an average pore diameter of 50 nm to 1000 nm of activated carbon was measured with a pore size distribution measuring apparatus (AUTOPORE IV) of Shimadzu Corporation under a mercury pressure of 1.35 psia to 60,000 psia.

A Raman spectrum was measured with a Raman spectrophotometer Holoprobe 532 of Kaiser Optical Systems, Inc., (Excitation light: Nd³⁺ of 532 nm, YAG laser, Detector: charge coupled device, Laser power: 4 mW to 10 mW). A half-value width of a D-band peak in the vicinity of 1360 cm⁻¹ and a half-value width of a G-band peak in the vicinity of 1580 cmcm⁻¹ were calculated. Since the BWC is a characteristic value depending on the kind of activated carbon, this was shown as an improvement rate compared with the reference examples in the following examples and comparative examples. Reference example 1, reference example 3, reference example 4, and reference example 5 each show the BWC and the packing density of activated carbon. Reference example 2, reference example 4, and reference example 6 each show a change in the BWC and in the packing density by pulverizing the activated carbons and then molding these.

### REFERENCE EXAMPLE 1

A metallic canister with an insulating-material lining was filled with woody activated carbon BAX-1500 (macropore volume of 0.5 mL/g, D-band half-value width of 236 cm⁻¹, G-band half-value width of 125 cm⁻¹, BWC/ASTM of 15) of Westvaco Corporation. 99% n-butane was supplied at an upflow of 1 L/minute at 25° C., and was adsorbed by an evaporated fuel gas adsorbent. When the concentration of n-butane at the exit reached 3000 ppm, the supply thereof was stopped. Thereafter, air was flowed at a downflow of 15 L/minute at room temperature for 20 minutes, and n-butane was desorbed. This adsorption and desorption step was repeatedly performed 10 times. The BWC was calculated from an average value of the amounts of adsorption and desorption of n-butane of the eighth to tenth adsorption and desorption operations. As a result, the BWC was 60.0 g/L, and the fill density was 0.310 g/mL

### REFERENCE EXAMPLE 2

Woody activated carbon BAX-1500 of Westvaco Corporation used in Reference Example 1 was pulverized. 100 g of activated carbon pulverized above, 120 g of water, 20 g of emulsion (NIKASOL FX-6074 of Nippon Carbide Industries Co. , Inc.), and 3 g of CMC were mixed together, and were subjected to injection molding by a plunger type extruding machine, thus obtaining activated carbon pellets each of which has a diameter of 2 to 3 mmΦ. These activated carbon pellets were then dried at 120°0 C., and were packed into a canister in the same way as in Reference Example 1. The BWC was measured. As a result, the BWC was 62.1 g/L. The packing density was 0.393 g/mL.

### REFERENCE EXAMPLE 3

Woody activated carbon FX-1135 (macropore volume of 0.35 mL/g, D-band half-value width of 216 cm⁻¹, G-band half-value width of 105 cm⁻¹, BWC/ASTM of 10.8) of PICA COMPANY was packed into a canister in the same way as in Reference Example 1. The BWC was measured. As a result, the BWC was 45.6 g/L. The packing density was 0.226 g/mL.

### REFERENCE EXAMPLE 4

Woody activated carbon FX-1135 of PICA COMPANY used in Reference Example 3 was pulverized. The BWC of activated carbon pellets obtained in the same way as in Reference Example 2 was measured. As a result, the BWC was 47.0 g/L. The packing density was 0.298 g/mL.

### REFERENCE EXAMPLE 5

Coal activated carbon 3GX (macropore volume of 0.5 m L/g, D-band half-value width of 82 cm⁻¹, G-band half-value width of 62 cm⁻¹, BWC/ASTM of 14.9) of Kuraray Chemical Co., Ltd., was used as activated carbon. This activated carbon was packed into a canister in the same way as in Reference Example 1. The BWC was measured. As a result, the BWC was 58.5 g/L. The packing density was 0.338 g/mL.

### REFERENCE EXAMPLE 6

Coal activated carbon 3GX of Kuraray Chemical Co., Ltd., used in Reference Example 5 was pulverized. The BWC of activated carbon pellets obtained by being molded in the same way as in Reference Example 2 was measured. As a result, the BWC was 54.7 g/L. The fill density was 0.340 g/mL.

### EXAMPLE 1

25 g of microcapsules (melting point of 40.2° C., cold crystallization temperature of 16.7° C., latent heat of 162 mJ/mg) of Mitsubishi Paper Mills Limited in each of which paraffinic hydrocarbon serving as a latent-heat storage material was encased, 75 g of pulverized woody activated carbon BAX-1500 of Westvaco Corporation used as activated carbon in Reference Example 1, 120 g of water, 20 g of emulsion (NIKASOL FX-6074 of Nippon Carbide Industries Co., Inc.), and 3 g of CMC were mixed together, and were subjected to injection molding by a plunger type extruding machine, thus obtaining an evaporated fuel gas adsorbent containing the microcapsules the diameter of each of which is 2 to 3 mmΦ. The latent heat of the obtained evaporated fuel gas adsorbent was 35 mJ/mg. The fill density was 0.387 g/mL.

A metallic canister with an insulating-material lining was filled with the evaporated fuel gas adsorbent of 1 L. 99% n-butane was supplied at an upflow of 1 L/minute at 25° C., and was adsorbed by the evaporated fuel gas adsorbent. When the was adsorbed by the evaporated fuel gas adsorbent. When the concentration of n-butane at the exit reached 3000 ppm, the supply thereof was stopped. Thereafter, air was flowed at a downflow of 15 L/minute at room temperature for 20 minutes, and n-butane was desorbed. This adsorption and desorption step was repeatedly performed 10 times. The BWC was calculated from an average value of the amounts of adsorption and desorption of n-butane of the eighth to tenth adsorption and desorption operations. As a result, the BWC was 70.0 g/L, and was improved by 13%.

### EXAMPLE 2

Except that 35 g of microcapsules of Mitsubishi Paper Mills Limited used in Example 1 and 65 g of pulverized woody activated carbon BAX-1500 were used, an evaporated fuel gas adsorbent was prepared in the same way as in Example 1. The latent heat of the evaporated fuel gas adsorbent obtained above was 55 mJ/mg, and the packing density was 0.393 g/mL. The BWC was 66.8 g/L, and was improved by 8%.

### EXAMPLE 3

Except that 15 g of microcapsules of Mitsubishi Paper Mills Limited used in Example 1 and 85 g of pulverized woody activated carbon BAX-1500 were used, an evaporated fuel gas adsorbent was prepared in the same way as in Example 1. The latent heat of the evaporated fuel gas adsorbent obtained above was 24 mJ/mg and the packing density was 0.371 g/mL. The BWC was 68.4 g/L, and was improved by 10%.

### EXAMPLE 4

Except that woody activated carbon FX-1135 of PICA COMPANY was used as activated carbon an evaporated fuel gas adsorbent was prepared in the same way as in Example 1. The latent heat of the evaporated fuel gas adsorbent obtained above was 33 mJ/mg and the packing density was 0.318 g/mL. The BWC was 55.6 g/L, and was improved by 18%.

### COMPARATIVE EXAMPLE 1

Except that coal activated carbon 3GX of Kuraray Chemical Co., Ltd., was used as activated carbon an evaporated fuel gas adsorbent was prepared in the same way as in Example 1. The latent heat of the evaporated fuel gas adsorbent obtained above was 29.9 mJ/mg, and the packing density was 0.368 g/mL. The BWC was 56.5 g/L. The improvement of the BWC was about 3% at the most and was at a lower level than in activated carbon that had not yet been pulverized. From the foregoing results, the effect of the present invention is highly beneficial.

### INDUSTRIAL APPLICABILITY

According to the present invention, it is possible to provide an evaporated fuel gas adsorbent that is excellent in volume efficiency and that is capable of fulfilling stable performance. According to the evaporated fuel gas adsorbent of the present invention, heat generated in accordance with the adsorption and desorption of an evaporated fuel gas can be efficiently managed. Therefore, an evaporated fuel gas absorption that has low volume and high efficiency can be realized without using unnecessary equipment for temperature adjustment or an expensive additive. The adsorbent of the present invention has a high function as an adsorbent for preventing fuel from being evaporated, and can prevent fuel from being evaporated especially from a vehicle. Therefore, the adsorbent is suitable for canisters or ORVR.

1. An evaporated fuel gas adsorbent formed by mixing together microcapsules in each of which a substance that absorbs or releases heat in response to phase change is encased and activated carbon and molding these integrally,
wherein a pore volume in an average pore diameter of from 50 nm to 1000 nm both inclusive of the activated carbon is 0.3 mL/g or more, and
wherein a half-value width of a D-band peak in the vicinity of 1360 cm⁻¹ and a half-value width of a G-band peak in the vicinity of 1580 cm⁻¹ are both equal to 100 cm⁻¹ or more in a Raman spectroscopic analysis.

2. The evaporated fuel gas adsorbent according to claim 1, wherein the substance that absorbs or releases heat in response to phase change is a substance that makes phase change at a temperature of −10° C. to 100° C.

3. The evaporated fuel gas adsorbent according to claim 1, wherein latent heat of the microcapsule in which a substance that absorbs or releases heat in response to phase change is encased is 80 mJ/mg or more.

4. The evaporated fuel gas adsorbent according to claim 1, wherein at least 50% or more of the activated carbon is made from a plant-based carbonaceous material.

5. The evaporated fuel gas adsorbent according to claim 1, wherein a butane working capacity measured in accordance with ASTM-D5228 of the activated carbon is 9 or more.

6. The evaporated fuel gas adsorbent according to claim 1, wherein a content ratio of the microcapsules in each of which a substance that absorbs or releases heat in response to phase change is encased is from 5% by weight to 40% by weight both inclusive.

7. The evaporated fuel gas adsorbent according to claim 1, wherein latent heat of the evaporated fuel gas adsorbent is 20 mJ/mg or more.

8. The evaporated fuel gas adsorbent according to claim 1, wherein an average particle diameter of the evaporated fuel gas adsorbent is from 0.5 mm to 5 mm.

9. A process for producing an evaporated fuel gas adsorbent, the process comprising the steps of:
mixing together powdery activated carbon and granular or powdery microcapsules in each of which a substance that absorbs or releases heat in response to phase change is encased in a solution chiefly composed of latex, carboxymethyl cellulose, and water,
subjecting a resulting mixture to wet molding, and
drying the mixture.
